(19) United States
(12) Patent Application Publication
(10) Pub. No.: US 2001/0010428 A1
(43) Pub. Date: Aug. 2, 2001

(54) Closing device, particularly for the trunk of a motor vehicle

(75) Inventor: Erhard Franz, Rodermark (DE)

Correspondence Address: Martin A. Farber, Suite 473, 866 United Nations Plaza, New York, NY, 10017, US

(73) Assignee: Mannesmann VDOAG

(21) Appl. No.: 09/775,268

(22) Filed: Feb. 1, 2001

Related U.S. Application Data
(63) Continuation of application No. 08/988,797, filed on Dec. 11, 1997, now abandoned.

(30) Foreign Application Priority Data
Dec. 24, 1996 (DE) 196 54 380.0

(51) Int. Cl. E05C 3/12

(52) U.S. Cl. 292/219

(57) ABSTRACT

A closing device, in particular for the trunk of a motor vehicle, having a closure bolt (2) arranged on a support (1) and guide elements (3) to receive a lock mechanism, the guide elements (3) being, in accordance with the invention, movable on the support (1), in particular swingable around an axis of rotation (4).

The present invention relates to a closing device, in particular for the trunk of a motor vehicle, in accordance with the features set forth in the preamble to claim 1.

A closing device of this type is known from EP 0 565 929 A1. A closure bolt which is gripped by a rotary trap of a lock mechanism upon the closing of a door, trunk, or the like is arranged on a support. Upon the closing process, the lock mechanism, which contains lock elements such as rotary latch, pawl and further elements, is guided by guide elements which are also arranged—adapted to the trapezoidal development of the lock mechanism—on the support. The support, the guide elements and possibly a part of the body of the car which is arranged parallel to the support above the guide elements form a shaft to receive the lock mechanism into which dirt can enter, which then impairs the operation of the lock mechanism. Furthermore, this shaft or else, if no shaft is present, the protruding closure bolt and possibly the guide elements constitute a source of injury upon the use of the motor vehicle.

The object of the invention is therefore to provide a closing device by which dirtying and the risk of injuries are effectively avoided.

This object is achieved in accordance with the invention by the features set forth in claim 1. The mobility of the guide elements arranged on the support has the advantage that, in the event that the lock mechanism is not within the shaft or between the guide elements and adjoins the closure bolt, the shaft is closed and thus no dirt can enter the shaft. Thus, it is also not accessible to service personnel, so that the risk of injuries is also excluded. In addition, the possibility of closing the shaft, particularly when the door, trunk or the like has been opened, has a pleasing optical effect. A longitudinal movement (displacement) of the guide elements can also be thought of for the freeing of the shaft upon the introduction.

Further advantageous embodiments of the invention are set forth in the dependent claims.

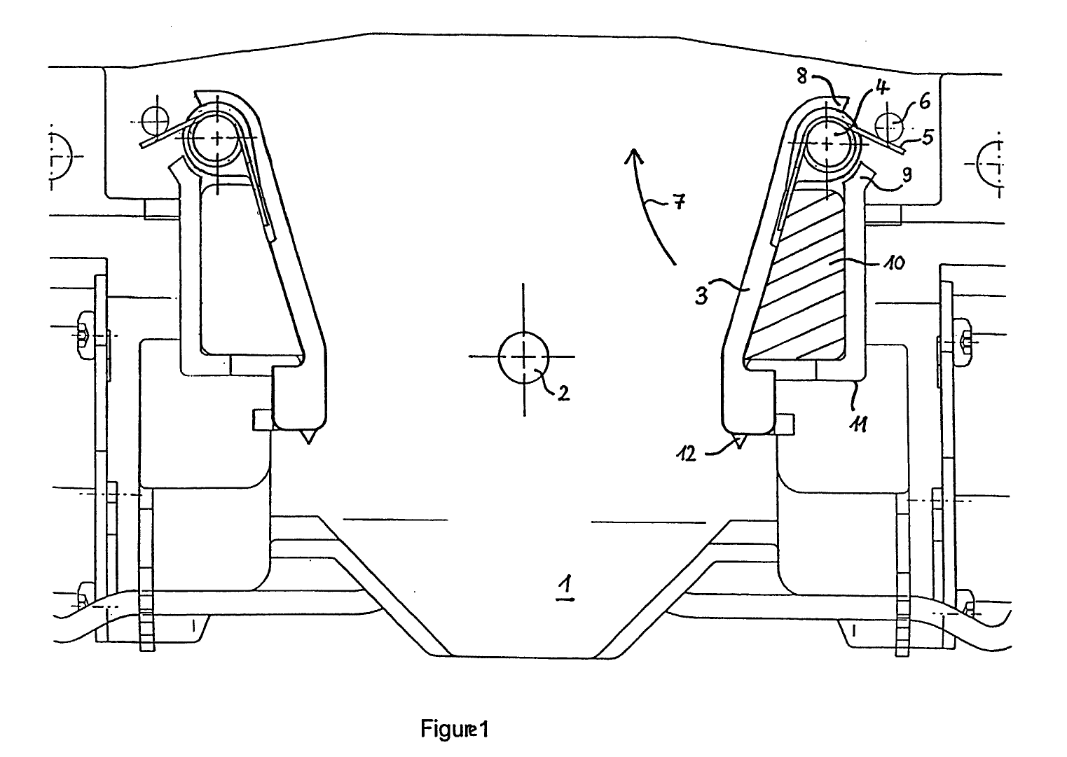

One embodiment—to which the general inventive concept, however, is not limited—is described below and shown in FIG. 1.

FIG. 1 shows, as part of the entire closing device, a support 1 on which a closure bolt 2 is arranged. The lock mechanism (not shown here), which comprises, for instance, rotary latch, pawl, and other known parts, is moved, viewed in FIG. 1, from above in the direction towards the closure bolt 2, in which connection the movement of the guide elements 3 arranged on the support 1 which are movable around an axis of rotation 4 are swung out. By this movement of the guide elements 3 around the axis of rotation 4, the shaft for the lock mechanism is freed of it and the closing device can be brought into its closed position, in which, for instance, a rotary trap grips around the closure bolt 2. When the rotary trap has been released by a pawl, the lock mechanism moves again out of the shaft. The guide elements 3 at first follow along in this movement since they are acted on by force. This takes place, in FIG. 1, by means of a spring 5 which rests, on the one hand, against the guide element 3, and, on the other hand, against a resting point 6 on the support 1. The movement of the guide elements 3 in a direction of rotation 7 takes place up to a point at which an end 8 of the corresponding guide element 3 comes against a stop 9 which is also arranged on the support 1 and thus stops the rotation of the guide elements 3. Thus the corresponding guide element 3, acted on by force (by means of the spring 5), is brought into a first position, in which the shaft is closed, and brought by the lock mechanism into a further position in which the shaft of the lock mechanism is accessible. In order to dampen the closing of the closing device, a damping element 10 is provided, which is either fastened (glued, screwed, clamped or the like) on the guide element 3 or is fastened in the same way on the support 1, in particular on an arm 11 arranged on the support 1. The damping element 10 is preferably fastened on the arm 11 and thus remains in a position of rest, so that, upon the movement of the guide elements 3, the moving masses are reduced. Furthermore, it can be provided that at least the part of the surface of the guide element 3 which covers the shaft or comes into contact with the lock mechanism be painted and/or provided with a coating in order effectively to reduce mechanical wear and increase the useful life.

Further embodiments of the invention are conceivable, without going beyond the inventive concept. Thus, for instance, with a suitable design, the spring 5 can at the same time assume the task of pretensioning and the task of damping, in which case further elements for the action of force on the guide elements are possible, such as, for instance, compression springs, hydraulic cylinders or the like. A hydraulic cylinder of a compressed air cylinder can, for instance, also be used as damping element.

Furthermore, the structure shown in FIG. 1 can be developed with the elements such as support 1, closure bolt 2 and the other elements described and shown as preassembled module. It is furthermore contemplated that the guide elements 3, including the elements corresponding thereto be arranged symmetrically to the closure bolt 2 or to the direction of movement of the lock mechanism (as is shown in FIG. 1). On the end facing away from the stop 8 of the guide element 3 there is a sealing lip 12 which, in particular, is elastically deformable and closes the region of impact between the two guide elements 3. A tightening aid by which, for instance, the closure bolt 2 can be driven around an eccentric axis can also be used.

A preferred use of the closure means of the invention is for the trunk of motor vehicles, these uses not representing the only field of use.

1. A closure device, in particular for the trunk of a motor vehicle, having a closure bolt (2) arranged on a support (1) as well as guide elements (3) to receive a lock mechanism, characterized by the fact that the guide elements (3) are arranged movably on the support (1), in particular each swingable about an axis of rotation (4).

2. A closure device according to claim 1, characterized by the fact that the guide elements (3) are arranged symmetrical to the direction of movement of the lock mechanism.

3. A closure device according to claim 1, characterized by the fact that the guide elements (3) can be brought, acted on by force, in particular by a spring (5), into a first position, and can be brought by the lock mechanism into a further position.

4. A closure device according to claim 3, characterized by the fact that the guide elements (3) in their first position come to rest against a stop (9).

5. A closure device according to claim 1, characterized by the fact that the guide elements (3) have, at least in part, a painting and/or a coating.

6. A closure device according to claim 1, characterized by the fact that damping elements (10) which come to rest on the support (1) or on an arm (11) arranged on the support (1) are fastened on the guide elements (3).

7. A closure device according to claim 1, characterized by the fact that damping elements which come to rest on the guide elements (3) are fastened on the support (1) or on an arm (11) arranged on the support (1).

8. A closure device according to claim 1, characterized by the fact that a sealing lip (12) is arranged on the end of the guide elements (3) facing away from the axis of rotation (4).

9. A closure device according to claim 1, in which the closing device has a tightening aid.

10. A closure device according to claim 1, in which the closure device has in each case, as module, the lock mechanism and the support (1) with the parts arranged thereon.
